(19) United States
(12) Patent Application Publication
(10) Pub. No.: US 2007/0160826 A1
(43) Pub. Date: Jul. 12, 2007

(54) Polymer composite with silane coated nanoparticles

(75) Inventors: Jin-Shan Wang, Pittsford, NY (US); Charles W. Lander, Wayland, NY (US); Jehuda Greener, Rochester, NY (US); Anne M. Miller, Batavia, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/327,117

(22) Filed: Jan. 6, 2006

(51) Int. Cl. B32B 5/16; B32B 15/02; B05D 7/00; B05D 3/12

(52) U.S. Cl. 428/331; 428/405; 427/356; 427/212

(57) ABSTRACT

The invention relates to a polymer composite, particularly an optical film, comprising a water insoluble polymer having dispersed therein inorganic nanoparticles modified on their surface with a monolayer of a silane of Formula 1.
X—SiR¹R²Y (I) wherein X is Cl or an alkoxy group;
R¹ and R² are independently Cl, an alkoxy group, or 13 CₙH₂ₙ₊₁; and Y is an organic functional group.

### FIELD OF THE INVENTION

The present invention relates to optical films. Specifically, the present invention relates to optical films comprising optical plastics and organically modified nanoparticles.

### BACKGROUND OF THE INVENTION

Optical materials and optical products are useful to control the flow and intensity of light. Examples of useful optical products include optical lenses such as Fresnel lenses, optical light fibers, light tubes, optical films including totally internal reflecting films, retroreflective sheeting, and microreplicated products such as brightness enhancing films (BEF) and security products. Brightness enhancement films are very useful in many of today's electronic products to increase the brightness of backlit flat panel displays such as liquid crystal displays (LCDs), electroluminescent panels, laptop computer displays, word processors, desktop monitors, televisions, video cameras, and automotive and avionic displays, among others.

An inorganic-polymer nanocomposite is defined as an interacting mixture of two phases, in which inorganic particulate is in the nanometer size of range (less than 1000 nm) in at least one dimension. By combing super physical property of inorganics and excellent processibility of polymer, inorganic-polymer nanocomposites have attracted a great deal of attention since many high-tech applications, such as micromechanical devices, memory storage media, sensors, display devices, and photonic band-gap materials, among others, can be fabricated by roll to roll (R2R) process such as solvent coating, extrusion, injection molding and others.

It is known that most inorganic nanoparticles and polymers are not compatible at the molecular level. Moreover, since the nanoparticle size is less than 1000 nm, the nanoparticles are thermodynamically unstable in a polymer matrix and tend to agglomerate to form much bigger particles during or after the fabrication process. Thus, it is still a difficult challenge to make optically transparent nanocomposite optics, especially at high loading of nanoparticles such as >30% by volume and with polymers that lack polar groups to disperse nanoparticles in solution and/or in solid state.

Surface initiating polymerization as taught by Patten et al. in J Am. Chem. Soc. 121, 7409-7410 (1999) offers the best solution to manufacture the inorganic-organic nanocomposite materials. However, there are several major drawbacks associated with so-called surface-initiated polymerization. First, in order to obtain high molecular weight polymer branches from nanoparticle surfaces, the loading of organic initiator-functionalized inorganic nanoparticles is inherently limited. Moreover, surface-initiated polymerization is mechanistically limited to vinyl monomers. Many of commercially important polymers do not work with surface-initiated polymerization. Furthermore, surface-initiating polymerization involves several very complicated synthetic processes and is currently hard to scale up. Thus, it is much more practical to fabricate the nanocomposite materials simply through roll to roll process such as solvent casting, extrusion molding, injection molding, etc.

There is still needed an improved optical film having good transparency, particularly one that can be fabricated using a roll-to-roll process.

### SUMMARY OF THE INVENTION

This invention provides a polymer composite comprising a water insoluble polymer having dispersed therein inorganic nanoparticles modified on their surface with a monolayer of a silane of Formula 1.
X—SiR¹R²Y (I)

wherein
X is Cl or an alkoxy group;
R¹ and R² are independently Cl, an alkoxy group, or —CₙH₂ₙ₊₁; and Y is an organic functional group.

The invention further provides a method of forming a polymer composite comprising bringing inorganic nanoparticles into contact with a silane of Formula 1 to form a monolayer of silane on said nanoparticles, mixing the modified nanoparticles with a polymer, and forming the mixture of nanoparticles and polymer into a polymer composite. In one embodiment the composite is utilized in an optical film, particularly a brightness enhancement film.

The invention provides an optical film with high transmittance. It further provides a method to obtain controllable birefringency and low dispersion in nanocomposite optical films. It also provides a method to obtain less negative dependence of refractive index on temperature in nanocomposite optical films. The invention further provides a method to obtain nanocomposite optical films with improved thermo-mechanical properties and thermodynamic stability, and one in which the nanoparticles do not agglomerate to form much bigger particles during or after the fabrication process. Such films may be particularly useful in LCD devices.

### BRIEF DESCRIPTION OF THE DRAWINGS

FIG. 1 depicts the transmission data of nanocomposite films prepared as shown in Examples 1 and 2.

FIG. 2 depicts TEM diagrams of nanocomposite films comprising tributyl cellulose acetate (CAB) with 50% (by weight) non-modified (A) and modified SiO₂ nanoparticles (B).

### DETAILED DESCRIPTION OF THE INVENTION

The present invention is directed to a polymer composite comprising a water insoluble polymer having dispersed therein inorganic nanoparticles modified on their surface with a monolayer of a silane of Formula 1.
X—SiR₁R₂Y (I).

In the above formula X is Cl or any alkoxy substitute, preferably methoxy or ethoxy. R₁ and R₂ are independently Cl, any alkoxy substitute, or —CₙH₂ₙ₊₁; wherein n is 2. In one embodiment the silane is an alkoxy silane.

Y represents any organic functional group. The organic group may function as a stabilizing group, an optical property modifier, an electronic property modifier, a liquid crystal group, a polymerizable group, etc. Preferably Y is an alkyl, aryl or functional group. Examples of Y include but are not limited to:

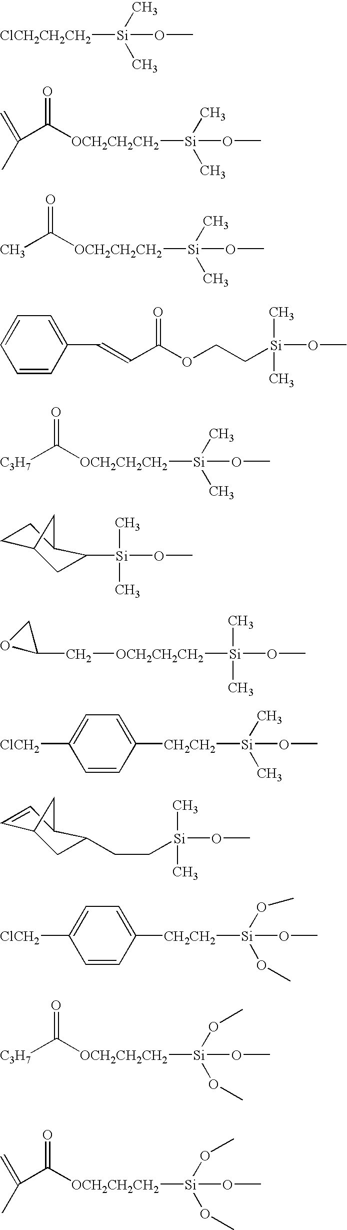

The method of forming the polymer composite comprises bringing inorganic nanoparticles into contact with a silane of Formula 1 to form a monolayer of silane on said nanoparticles, mixing the modified nanoparticles with a polymer, and forming the mixture of modified nanoparticles and polymer into a polymer composite, as described in more detail in the examples. In accordance with one embodiment of the invention, the modified inorganic oxide nanoparticles are selected from a group of inorganic nanoparticles with multi-hydroxy groups on the nanoparticle surface. The inorganic nanoparticles include, but are not limited to, SiO₂, ZrO₂, TiO₂, Al₂O₃, SnO₂, Sb₂O₃, MgO, Eu₂O₃, and ZnO. These nanoparticles may be doped with other types of elements.

In accordance with another embodiment of the invention, the average size of the nanoparticles is less than 1000 nm, preferably less than 500 nm, most preferably less than 100 nm. In accordance with another embodiment of the invention, the shape of the inorganic oxide nanoparticles can vary. The nanoparticles may be, for example, spherical nanoparticles, elongated nanoparticles, chain nanoparticles, needle-shaped nanoparticles, and core-shell nanoparticles, or combinations thereof.

In accordance with an embodiment of the invention, the amount of organic functional groups that are incorporated on the surface of the nanoparticles varies from 1% to 30% by weight, preferably from 2% to 20% by weight.

The water insoluble polymer, or hydrophobic polymer, described in the present invention is defined as one that is not soluble in water at a level of more than 0.01% by weight. The hydrophobic polymers used in the present invention can be selected from any polymers as defined above. They include but not limited to poly alkyl methacrylates and their copolymers such as poly(methyl methacrylate) and its copolymers, poly styrene and its derivatives, polyesters such as PET and PEN, polycarbonates, polyarylates, poly olefins such as poly ethylene and polypropylene, poly (cyclo-olefins) such as Arton from Japanese Synthetic Rubber, Topas, Aperal 3000, Zeonor, poly vinyl acetate, and cellulose acetates such as trimethyl cellulose acetate and tributyl cellulose acetate. Preferably the polymer comprises trimethyl cellulose acetate or cellulose acetate butyrate.

In nanocomposite materials, it advantageous to use organically modified nanoparticles, since homogenous nanocomposite materials with very high inorganic nanoparticle loading can be obtained. In accordance with an embodiment of the invention, the loading level of organically functionalized nanoparticles varies from 0.1% to 99% by volume. For many applications, the loading level of organically functionalized nanoparticles is preferably higher than 15% by volume. In one embodiment the polymer composite comprises between 10 and 50% by weight of said modified inorganic nanoparticles.

The polymer composite may take various forms. It can be in the form of a film, particularly an optical film. In one embodiment said polymer composite comprises a film of a thickness of between 50 and 150 micrometers. The polymer composite may be a film on a glass substrate. In another embodiment the polymer composite may be a film on a polymer sheet. In a preferred embodiment the polymer composite film is between a glass substrate and a polymer sheet.

Nanocomposite optical films can be made by any processing method. Solvent coating and extrusion process are two mostly common methods to make nanocomposite films. In the solvent coating method the modified nanoparticles and the polymer are mixed in the presence of a solvent, the mixture is coated and the solvent is removed to form a polymer composite. By using different nanoparticles, the physical and especially optical properties in nano-optical films can be designed and controlled. In a preferred embodiment, the refractive index can be controlled by incorporating organically functionalized nanoparticles with high refractive index.

In another preferred embodiment, one may control the birefringency of nano-optical film by using elongated nanoparticles i.e. the polymer composite has a tunable birefringence. In one embodiment the polymer composite has a tunable birefringence of −100 nm to 100 nm.

In yet another preferred embodiment, one may control the dn/dt of nano optical film by using organically modified nanoparticles with less negative or positive dn/dt. In yet another preferred embodiment, one may enhance the thermo-mechanical property by incorporating organically modified nanoparticles. In yet more preferred embodiment, the elongated nanoparticles are used to improve thermo-mechanical property even more.

In one embodiment the polymer composite has a light transmittance of greater than 80% at 560 nanometers, and more preferably greater than 90%. It is preferred that the polymer composite has a refractive index of between 1.47 and 2.0. The polymer composite preferably has a temperature dependence of refraction of between −80 and 0 per degree centigrade.

The following examples are intended to illustrate, but not to limit, the invention

### EXAMPLES

### Example 1-2

### Tributyl Cellulose Acetate and Norbornene Dimethyethoxysilane Functionalized Spherical SiO₂ Nanocomposite Films

Synthesis of Organic Silane Functionalized Nanoparticle

In general, functionalized nanoparticles were obtained by reacting organic silane and nanoparticles in organic solvent. The following is a typical example for synthesis of (p-chloromethyl)phenyl trimethoxysilane functionalized spherical SiO₂ nanoparticle in toluene. (p-chloromethyl)phenyl trimethoxysilane functionalized SiO₂ nanoparticles were synthesized as follows. 17 grams of 30wt % 8 nm SiO2 nanoparticle dispersion in methanol that was purchased from Nissan Chemicals, known as MA-ST-S™, and 90 ml of methanol were charged into a 500 ml three-neck round bottom flask equipped with an addition funnel, distillation condenser, and a magnetic stir bar. When the dispersion started the refluxing, a solution containing 0.75 grams of (p-chloromethyl)phenyl trimethoxysilane (Aldrich) and 100 ml of toluene was drop by drop added to the nano SiO2 methanol dispersion. When almost no methanol could be distillated out at ca. 65° C., a new dispersion containing (p-chloromethyl)phenyl trimethoxysilane functionalized SiO₂ nanoparticles and toluene was collected.

Preparation of the Coating Liquid:

The 8 nm SiO₂ particles, that are modified or unmodified, were combined with tributyl cellulose acetate polymer in methyl ethyl ketone through the use of a cowles blade (or any other means of effective stirring where shear is introduced causing a vortex). The particles were added as a stream to the vortex at a rate equal to the rate at which the vortex is capable of sweeping the SiO₂ stream immediately under the surface thus dispersing it throughout the whole. Stirring was maintained for 5 minute then discontinued. The mixture was then capped and placed on rollers overnight (approx. 16 hours) to insure complete mixing and to remove any air introduced during the cowles step.

With certain mixtures of high viscosity, it may be necessary to utilize sonification to aid in the removal of gas bubbles generated during the preparation of the coating liquid.

Coating of the Liquid:

Depending on the surface tension of the liquid mixture, one of three substrates may be utilized as the surface upon which the casting will be accomplished. The three substrates are: PTFE/Kapton for relatively low surface tensions, Bare PET for medium surface tensions, and Bare PEN for mixtures of higher surface tension. The choice of substrate is usually a result of trial and error.

The substrate was vacuum held to an aluminum platen through which heated water was circulated to aid removal of the casting solvent. The liquid mixture was applied to the substrate using knife-edge blades of various gap settings thus accomplishing the desired dry coverage or thickness. The application speed was relative to the liquid's viscosity to minimize skipping while the drying rate was relative to the boiling point of the casting solvent to allow leveling prior to setting. At the appropriate point of drying the layer was then stripped off as a freestanding film. The film was then placed in a 60 degree centigrade ambient oven for 3 hours to complete the removal of the casting solvent.

Table 1 shows the characterization data for tributyl cellulose acetate and norbomene dimethyethoxysilane functionalized spherical SiO₂ nanocomposites.

TABLE 1

| Example | SiO₂%, wt/wt | Thickness, mm | Observation |
|---|---|---|---|
| Comparative | 0 | 0.43 | Very transparent |
| 1 | 25 | 0.31 | Very transparent |
| 2 | 50 | 0.35 | transparent |
| Comparative | 50^{a} | 0.20 | opaque |

^{a}non-modified.

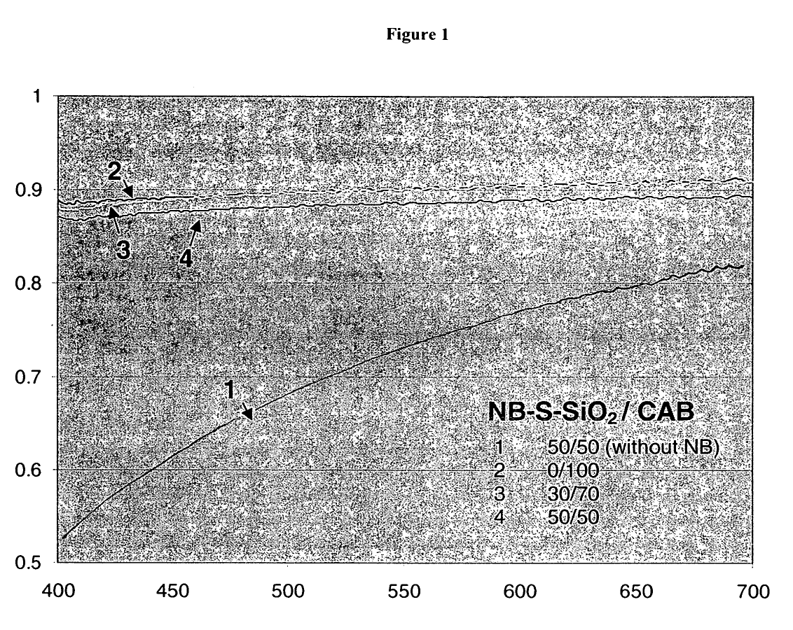

FIG. 1 shows the transmission data of nanocomposite films prepared as described above. It is clear that, while nanocomposite film comprising CAB and 50% non-modified SiO₂ nanoparticles by weight show much lower transparency over the range of 400 to 700 nm, the one comprising CAB and the same 50% modified SiO₂ nanoparticles by weight show almost identical transparency to pure CAB film. It was also observed that nanocomposite film comprising CAB and 50% non-modified SiO₂ nanoparticles by weight is very transparent, whereas the one comprising CAB and the same 50% unmodified SiO₂ nanoparticle is opaque.

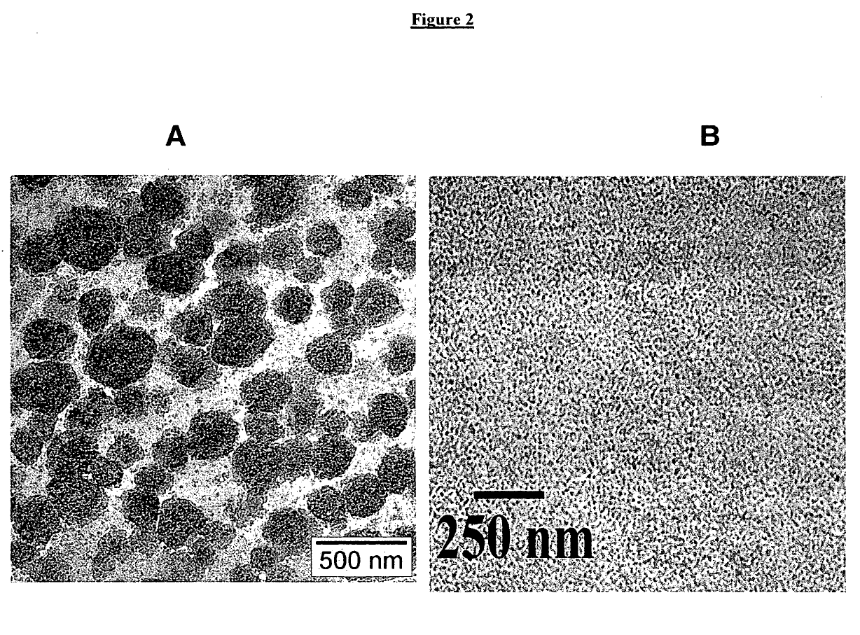

FIG. 2 compares TEM diagrams of nanocomposite films comprising CAB with 50% (by weight) non-modified (A) and modified SiO₂ nanoparticles (B). It is clear that for nanocomposite films comprising modified SiO₂ nanoparticles, no considerable change can be detected, whereas for nanocomposite films comprising non-modified SiO₂ nanoparticles, the size of the SiO₂ nanoparticles was increased to as large as 400 nm from the original 8 nm due to some unknown reason. Nevertheless, in contrast to modified SiO₂, all these results indicate that unmodified SiO₂ nanoparticles are not stable and tend to agglomeration during the course of processing.

### Examples 3-5

### Tributyl Cellulose Acetate and Acetoxyisopropyl Dimethyethoxysilane Functionalized Elongated SiO₂ Nanocomposite Films

The nanocomposite films were made as described in examples 1-3. Table 1 shows the characterization data.

TABLE 2

| Example | SiO₂%, wt/wt | Thickness, mm | Observation |
|---|---|---|---|
| 3 | 30 | 0.51 | Very transparent |
| 4 | 50 | 0.45 | transparent |
| 5 | 60 | 0.49 | transparent |
| comparative | 50^{a} | 0.5 | opaque |

^{a}non-modified.

### Example 6

### Poly Methyl Methacryalte and Acetoxymethyldimethyethoxysilane Functionalized Elongated SiO₂ Nanocomposite Films

Polymethylmethacrylate nanocomposite optical plastic film comprises a polymethylmethacrylate host material having a temperature sensitive optical vector x₁ and silica nanoparticles having a temperature sensitive optical vector x₂ dispersed in the polymethylmethacrylate host material. More particularly, a polymethylmethacrylate host material was optically modified with the addition of 8 nm spherical silica nanoparticles that were modified by 15 wt % of organic silane compound (S1).

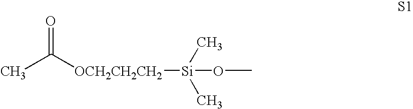

For the combination of polymethylmethacrylate and organically modified spherical silica, the dn/dt of the nanocomposite nanoparticles is reduced by approximately 25% by adding 30% of organically modified spherical silica by weight (%).

### Comparative Example

The experimental conditions used to make the film were identical to example 7, except that an un-modified MA-St-UP™ was used instead of the functionalized one. The film is opaque.

### Example 7

### Arton and Norbornene Dimethyethoxysilane Functionalized Spherical SiO₂ Nanocomposite Films

Cyclic olefin polymer nanocomposite optical plastic comprises a cyclic olefin polymer host material having a temperature sensitive optical vector x₁ and silica nanoparticles having a temperature sensitive optical vector x₂ dispersed in the cyclic olefin polymer host material (CP1) with the following structure. According to the requirements of the invention, x₁ is directionally opposed to x₂.

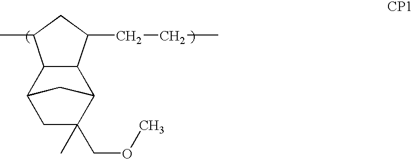

More particularly, a cyclic olefin polymer host material was optically modified with the addition of 8 nm spherical silica nanoparticles (NP1) that were modified by 25 wt % of organic silane compound S1.

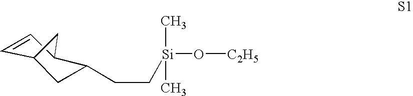

For the combination of cyclic olefin polymer and organically modified spherical silica, the dn/dt of the nanocomposite nanoparticles is reduced by approximately 22% by adding 30% of NP1 by weight (%).

The invention has been described in detail with particular reference to certain preferred embodiments thereof, but it will be understood that variations and modifications can be effected within the spirit and scope of the invention.

1. A polymer composite comprising a water insoluble polymer having dispersed therein inorganic nanoparticles modified on their surface with a monolayer of a silane of Formula 1.
X—SiR¹R²Y (I)
wherein
X is Cl or an alkoxy group;
R¹ and R² are independently Cl, an alkoxy group, or —CₙH₂ₙ₊₁; and
Y is an organic functional group.

2. The polymer composite of claim 1 wherein said polymer comprises trimethyl cellulose acetate.

3. The polymer composite of claim 1 wherein said polymer comprises cellulose acetate butyrate.

4. The polymer composite of claim 1 wherein said inorganic nanoparticles comprise silicon dioxide or titanium dioxide.

5. The polymer composite of claim 1 wherein said inorganic nanoparticles are spherical or elongated spherical in shape.

6. The polymer composite of claim 1 wherein Y is represented by one of the following structures:

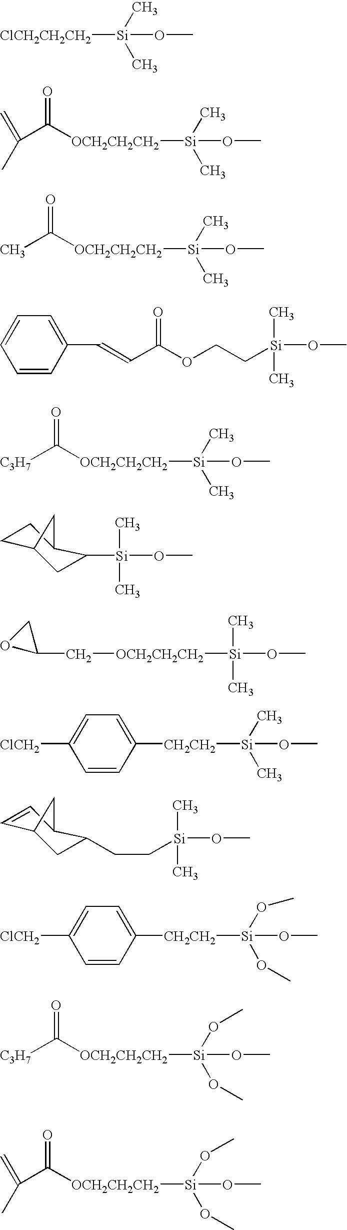

7. The polymer composite of claim 1 wherein said silane is an alkoxy silane.

8. The polymer composite of claim 1 wherein said polymer composite comprises between 10% and 50% by weight of said modified inorganic nanoparticles.

9. The polymer composite of claim 1 wherein said nanoparticles have an average particle size of between 1 and 500 nanometers.

10. The polymer composite of claim 1 wherein said polymer composite has a light transmittance of greater than 90% at 560 nanometers.

11. The polymer composite of claim 1 wherein said polymer composite has a tunable birefringence.

12. The polymer composite of claim 1 wherein said polymer composite has a tunable birefringence of −100 nm to 100 nm.

13. The polymer composite of claim 1 wherein said polymer composite has a refractive index of between 1.47 and 2.0.

14. The polymer composite of claim 1 wherein said polymer composite has a temperature dependence of refraction of between −80 and 0 per degree centigrade.

15. The polymer composite of claim 1 wherein said polymer composite comprises a film of a thickness of between 50 and 150 micrometers.

16. The polymer composite of claim 1 wherein said polymer composite is on a glass substrate.

17. The polymer composite of claim 1 wherein said polymer composite is on a polymer sheet.

18. The polymer composite of claim 1 wherein said polymer composite is between a glass substrate and a polymer sheet.

19. A method of forming a polymer composite comprising bringing inorganic nanoparticles into contact with a silane of Formula 1 to form a monolayer of silane on said nanoparticles, mixing the modified nanoparticles with a polymer, and forming the mixture of nanoparticles and polymer into a polymer composite.

20. The method of claim 19 wherein said modified nanoparticles and said polymer are mixed in the presence of a solvent, coating the polymer, solvent and nanoparticle mixture, and removing said solvent to form a polymer composite.

21. The method of claim 19 wherein the forming of said polymer composite is by extrusion.

22. An optical film comprising a polymer composite comprising a water insoluble polymer having dispersed therein inorganic nanoparticles modified on their surface with a monolayer of a silane of Formula 1:
X—SiR¹R²Y (I)
wherein
X is Cl or an alkoxy group;
R¹ and R² are independently Cl, an alkoxy group, or —CₙH₂ₙ₊₁; and
Y is an organic functional group.

23. The optical film of claim 22 wherein Y is represented by one of the following structures: [chemical structure]
